(19) United States
(12) Patent Application Publication
(10) Pub. No.: US 2003/0018599 A1
(43) Pub. Date: Jan. 23, 2003

(54) Embedding a wavelet transform within a neural network

(76) Inventor: Michael C. Weeks, Avondale Estates, GA (US)

Correspondence Address: NEEDLE & ROSENBERG P C, 127 PEACHTREE STREET N E, ATLANTA, GA, 30303-1811, US

(21) Appl. No.: 10/124,882

(22) Filed: Apr. 18, 2002

Related U.S. Application Data
(60) Provisional application No. 60/286,110, filed on Apr. 23, 2001.

(51) Int. Cl. G06F 15/18; G06E 1/00

(52) U.S. Cl. 706/15

(57) ABSTRACT

Artificial neural networks are configured or programmed to implement or embody wavelet transforms or portions thereof such as filters. The processing elements or neurons are connected to each other in a manner that reflects the matrix multiplications that characterize wavelet transforms. The neural networks can embody one-dimensional, two-dimensional and greater wavelet transforms over one or more octaves. The configured neural networks can thus be used for image processing, audio processing, compression and other uses in the manner of conventional wavelet transform logic.

### CROSS-REFERENCE TO RELATED APPLICATION

The benefit of the filing date of U.S. Provisional Patent Application Serial No. 60/286,110 filed Apr. 23, 2001, entitled “EMBEDDING THE WT WITHIN A NEURAL NETWORK,” is hereby claimed, and the specification thereof incorporated herein in its entirety.

### BACKGROUND OF THE INVENTION

1. Field of the Invention

The present invention relates generally to wavelet transforms and also relates to artificial neural networks.

2. Description of the Related Art

An artificial neural network is a logic structure, implemented in software, hardware or some combination thereof, comprising a network of interconnected processing elements. The processing elements and their interconnections are somewhat analogous to the neurons and their biological interconnections in a brain. Each neural processing element has two or more weighted signal inputs. In implementations in digital logic, the processing element computes as its output the sum of the product of the value at each input and the weight or coefficient assigned to that input. In other words, each processing element essentially performs a multiplying summation function. Through back propagation and other techniques, results at the output of the neural network are used as feedback to adjust the weights. Stated another way, the neural network modifies its structure by changing the strength of communication between processing units (called neurons) to improve its performance. By presenting the neural network with a large enough set of data, it can be trained for a specific processing task. Neural networks can thus learn complex, nonlinear relationships between inputs and outputs by exposure to input patterns and desired output patterns. Following training, the neural network is able to generalize to provide solutions to novel input patterns, provided that the training data was adequate.

Wavelet transforms have found a great number of uses in data compression and other areas. Like any mathematical transform, such as its forebear the Fourier transform, the wavelet transform can relate signals describing information in one domain, such as the time domain, to signals describing the same information in another domain, such as the frequency domain. The wavelet transform passes the time-domain signal through various high pass and low pass filters, which filter out either high frequency or low frequency portions of the signal. For example, in a first stage a wavelet transform may split a signal into two parts by passing the signal through a high pass and a low pass filter, resulting in high pass filtered and low pass filtered versions of the same information. The transform then takes either or both portions, and does the same thing again. This operation is known as decomposition or analysis.

More specifically, wavelets are generated by a pair of waveforms: a wavelet function and a scaling function. As the name suggests, the wavelet function produces the wavelets, while the scaling function finds the approximate signal at that scale. The analysis procedure moves and stretches the waveforms to male wavelets at different shifts (i.e., starting times) and scales (i.e., durations). The resulting wavelets include coarse-scale ones that have a long duration and fine-scale ones that last only a short amount of time.

A discrete wavelet transform (DWT) convolves the input signal by the shifts (i.e., translation in time) and scales (i.e., dilations or contractions) of the wavelets. In the literature, the value J is commonly used to represent the total number of octaves (i.e., levels of resolution), while j is an index to the current octave (1<=j<=J). The value N is used to represent the total number of inputs, while n is an index to the input values (1<=n<=N). Wₕ(n,j) represents the DWT output (detail signals). W(n,O) indicates the input signal, and W(n,j) gives the approximate signal at octave j. In the equations below, h refers to the coefficients for the low-pass filter, and g refers to the coefficients for the high-pass filter.

The low-pass output is:

$$W ( n , j ) = {\sum }_{m = 0}^{2 n} W ( m , j - 1 ) h ( 2 n - m )$$

The high-pass output

$${W}_{h} ( n , j ) = {\sum }_{m = 0}^{2 n} W ( m , j - 1 ) g ( 2 n - m )$$

A number of algorithms are known in the art for computing the low and high-pass outputs relating to a one-dimensional DWT, such as the fast pyramid algorithm. The fast pyramid algorithm is efficient because it halves the output data at every stage, which is known as downsampling. Note that every octave divides the value n by 2, because the DWT outputs are downsampled at every octave. Because a DWT keeps only half of the filter outputs, only half need to be computed. The wavelet filters generates N/2^{j} outputs for each octave, for a total of N/2|N/4|N/8| . . . |1=N outputs. The scaling filters also generate N/2^{j} values, but these are used only internally (i.e., they are inputs to the next pair of filters), except for the last octave. The maximum number of octaves is based on input length, J=log₂(N), however in commercial examples of DWT algorithms, such as those used in image processing, the number of octaves is typically no more than three (i.e., J=3). Although downsampling is common for reasons of efficiency, wavelet transform algorithms that do not downsample are also used. Such an algorithm may be referred to as a continuous wavelet transform (CWT).

It would be desirable to provide fast and efficient wavelet transform logic for image processing and other uses that can readily be implemented using commercially available hardware or software. The present invention addresses these problem and others in the manner described below.

### SUMMARY OF THE INVENTION

The present invention relates to neural networks configured or programmed to embody or implement wavelet transform logic and portions thereof such as filters. The neural networks can be configured to implement both discrete wavelet transforms and continuous wavelet transforms. The neural networks can be configured to implement a transform in any suitable number of dimensions. The wavelet transform can also have any suitable number of octaves. Each octave can be conceptualized as a layer of neural processing elements. In a first octave or layer of the transform, a plurality of inputs are coupled to each of two groups of processing elements or artificial neurons: a low-pass group and a high-pass group. The “low-pass” neural processing elements are referred to by that name because their inputs are weighted with coefficients that characterize a low-pass filter. Likewise, the “high-pass” neural processing elements are referred to by that name because their inputs are weighted with coefficients that characterize a high-pass filter. Because each input is coupled to a number of processing elements, the configuration reflects the matrix multiplication that characterizes wavelet transforms. The output or outputs of the low-pass processing elements and the output or outputs of the high-pass processing elements together characterize a wavelet transform output. Additional octaves can be included in the wavelet transform by including additional layers of processing elements, with at least some of the outputs of one layer providing inputs to the next layer.

It is to be understood that both the foregoing general description and the following detailed description are exemplary and explanatory only and are not restrictive of the invention, as claimed.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 illustrates an artificial neural network configured to perform a discrete wavelet transform;

FIG. 2 illustrates a one-dimensional, one-octave artificial neural network configured to perform a discrete wavelet transform;

FIG. 3 illustrates the low-pass portion of a one-dimensional, one-octave artificial neural network configured to perform a continuous wavelet transform;

FIG. 4 illustrates a one-dimensional, three-octave artificial neural network configured to perform a discrete wavelet transform;

FIG. 5 illustrates a two-dimensional wavelet transform using an artificial neural network shown in generalized form to convey the concept; and

FIG. 6 illustrates a two-dimensional wavelet transform using an artificial neural network shown in further detail.

### DETAILED DESCRIPTION

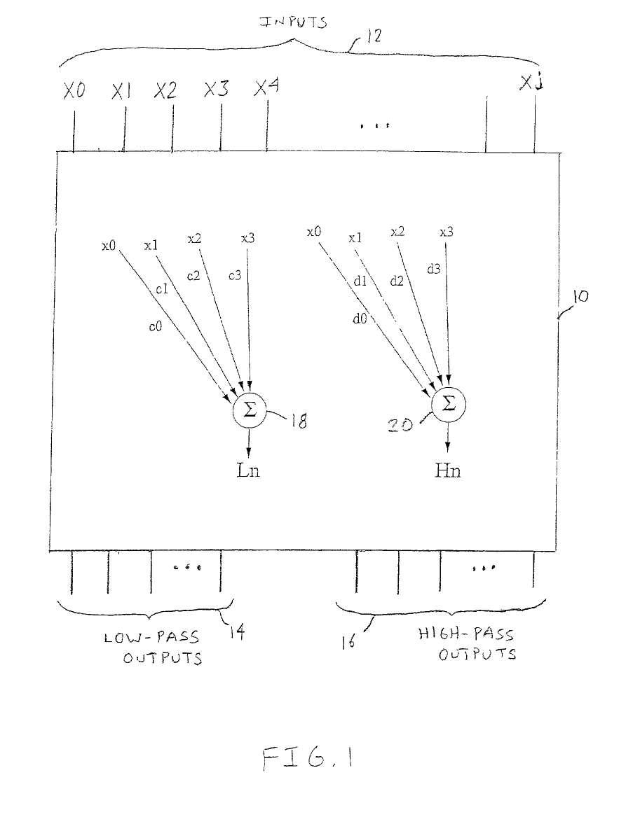

As illustrated in FIG. 1, an artificial neural network 10 configured to perform a wavelet transform has a plurality of j inputs 12, denoted XO through X(j-1). (In other words, j can be any integer greater than one.) For example, in an embodiment of the invention in which there are 16 inputs (i.e., j=16), they are denoted X0 through X15. In some embodiments of the invention, neural network 10 can be configured to perform either a discrete wavelet transform (DWT), and in other embodiments can be configured to perform a continuous wavelet transform (CWT). In all embodiments, there are a plurality of low-pass outputs 14 and a plurality of high-pass outputs 16. The number of outputs 14 and 16 depends upon whether neural network 10 is configured to perform a DWT or is configured to perform a CWT and, as discussed below, the number of octaves of resolution it is configured to have. For example, in DWT embodiments having only a single octave, there are j/2+1 low-pass outputs 14 and j/2+1 high-pass outputs 16. Thus, for example, if j is 16, there are nine low-pass outputs 14 and nine high-pass outputs 16. In CWT embodiments having only a single octave, there are j+2 low-pass outputs 14 and j+2 high-pass outputs 16. Embodiments having one octaves, two octaves and three octaves are described below in further detail.

Neural network 10 can comprise any suitable digital logic, including not only special-purpose neural network integrated circuit chips and other hardware devices but also general purpose computers programmed with neural network software. Like any artificial neural network, neural network 10 includes a large number of neural processing elements such as elements 18 and 20. Only two such elements 18 and 20 are illustrated in FIG. 1 for purposes of clarity and illustration of the general concept, but as persons skilled in the art to which the invention relates understand, neural network 10 includes a large number of such elements that can be interconnected by programming or configuring neural network 10 using programming or configuration methods well-understood in the art. Commercially available neural network chips and neural network software can be readily programmed or configured by following instructions provided by their manufacturers. Although it is contemplated that economical, commercially available neural networks 10 can be programmed or configured by persons skilled in the art in accordance with the invention, such persons may alternatively choose to create their own neural network 10 embodied in hardware or software logic. The knowledge needed to make a generalized neural network is well-within the abilities of persons skilled in the art, and this patent specification enables such persons to program or configure its interconnections to specifically perform a DWT, CWT or sub-function thereof, such as high-pass, low-pass or band-pass filtering. The terms “programming” a neural network, “configuring” a neural network and similar terms are intended to be synonymous, although one such term may be more commonly used in the art in the context of a specific commercial example of a neural network hardware device or software program than the others. Programmed or configured in accordance with this invention, neural network 10 can be used for any suitable purpose for which it is known in the art to use a wavelet transform or a filter. Neural network 10 can be used in conjunction with any other suitable hardware or software known in the art, such as that which is conventionally used for image processing and data compression, in place of the hardware or software that conventionally performs wavelet transform or filtering functions. In any such embodiment, whether hardware or software or a combination thereof, neural network 10 has an output interface with low-pass outputs 14 and high-pass outputs 16.

Although described below in further detail, the low-pass filtering function is performed by a plurality of low-pass neural processing elements 18, the essential function of each of which is to perform a multiplying summation. That is, each element 18 multiplies a plurality of values by a plurality of corresponding coefficients and sums the resulting products together. For example, as illustrated in FIG. 1, element 18 produces the sum Lₙ: x0c0+x1c1+x2c2+x3c3. Likewise, the high-pass filtering function is performed by a plurality of high-pass neural processing elements 20, the essential function of each of which is to perform a multiplying summation. That is, each element 20 multiplies a plurality of values by a plurality of corresponding coefficients and sums the resulting products together. For example, as illustrated in FIG. 1, element 20 produces the sum Hₙ: x0d0+x1d1+x2d2+x3d3. Note that the same values x0, x1, x2 and x3 are provided to element 18 and element 20. The combined effect of high-pass filtering and low-pass filtering the same input values, as illustrated by the functions of elements 18 and 20, is a defining characteristic of a wavelet transform. Nevertheless, a neural network configured or programmed to perform high-pass filtering, low-pass filtering, band-pass filtering or a combination thereof, or any similar filtering function is, by itself, considered to be within the scope of the present invention, as are other aspects and structures of the neural network as a whole.

As known in the art, the coefficients c0, c1, c2 and c3 are selected to produce a low-pass filtering effect, and coefficients d0, d1, d2 and d3 are selected to produce a high-pass filtering effect. Persons skilled in the art understand how such coefficients are selected and the values that will produce the desired filtering effect. For example, it is well-known that for a Daubechies wavelet, the low-pass coefficients are: c0=1+sqrt(3), c1=3+sqrt(3), c3=3−sqrt(3) and c3=1−sqrt(3), where “sqrt( )” symbolizes a square root function. Likewise for a Daubechies wavelet, the high-pass coefficients are: d0=1−sqrt(3), d1=−3+sqrt(3), d2=3+sqrt(3) and d3=−1−sqrt(3). The filter coeficients can be normalized by dividing by 4sqrt(2), as known in the art.

Note that although the constants by which the values are multiplied are referred to as filter “coefficients,” in the context of neural networks they can also be referred to as “weights.” The inputs to neural processing elements 18 and 20, for example, are weighted with the low-pass and high-pass filter coefficients instead of other types of weights that may be used in conventional neural networks.

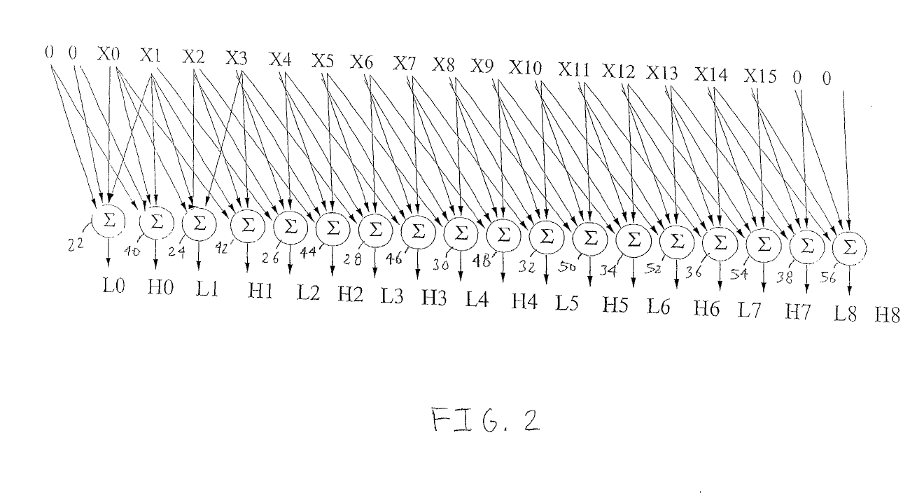

As illustrated in FIG. 2, an example of a neural network 10 configured or programmed to perform a one-dimensional, one-octave DWT has 16 inputs, X0 through X15, and includes 18 neural processing elements 22, 24, 26, 28, 30, 32, 34, 26, 38, 40, 42, 44, 46, 48, 50, 52, 54 and 56. The choice of 16 inputs is arbitrary and for purposes of illustration only; embodiments of the invention can have any suitable number of inputs and correspondingly suitable number of neural processing elements. Neural processing elements 22-56 can be conceptually grouped into low-pass neural processing elements 22-38 and high-pass neural processing elements 40-56.

Note that if j represents the number of inputs in the embodiment, there are at least j/2 low-pass neural processing elements and at least j/2 high-pass neural processing elements. Also note that there exists at least one low-pass neural processing element (which can be referred to as an “nth” one of them, where n is an integer index) that provides a low-pass first-octave output (L_{0,n}) comprising the sum of: the product of a first low-pass filter coefficient and input 2n−k, the product of a second low-pass filter coefficient and input 2n−(k−1), the product of a third low-pass filter coefficient and input 2n−(k−2), continuing this process until the kth low-pass filter coefficient is multiplied by input 2n, where k is the number of filter coefficients. For example, if low-pass neural processing element 22 is referred to for convenience as the first (i.e., n=0), low-pass neural processing element 24 is referred to as the second (i.e., n=1), low-pass neural processing element 26 is referred to as the third (i.e., n=2), low-pass neural processing element 28 is referred to as the fourth (i.e., n=3), and so forth, and there are four filter coefficients (i.e., k=4), then, for example, the fourth (4^{th}) low-pass neural processing element 28 (i.e., n=3) provides a low-pass first-octave output L3 comprising the following sum: X3c0+X4c1+X5c2+X6c3, where c0, c1, c2 and c3 are the four low-pass filter coefficients or weights associated with the inputs of each low-pass neural processing element. Fourth low-pass neural processing element 28 is mentioned only as an example of one such element that provides the summation function described above; note that in the embodiment illustrated in FIG. 2 there are a number of other such “nth” low-pass neural processing elements that also provide such a low-pass first-octave output (L_{0,n}) i.e., they satisfy the above-described formula in terms of indices n and k. In any given embodiment, there may be some number of low-pass neural processing elements that do not satisfy the formula, such as elements 22 and 38 in the illustrated embodiment. Note that elements 22, 40, 38 and 56 do not satisfy the formula because they receive a constant of zero as one or more of their input values.

Similarly, there exists at least one high-pass neural processing element (which can be referred to as an “nth” one of them, where n is an integer index) that provides a high-pass first-octave output (H_{0,n}) comprising the sum of: the product of a first high-pass filter coefficient and input 2n−k, the product of a second high-pass filter coefficient and input 2n−(k−1), the product of a third high-pass filter coefficient and input 2n−(k−2), continuing this process until the kth low-pass filter coefficient is multiplied by input 2n, where k is the number of filter coefficients. For example, the sixth (6^{th}) high-pass neural processing element 50 (i.e., n=5) provides a high-pass first-octave output H5 comprising the following sum: X8d0+X9d1+X10d2+X11d3, where d0, d1, d2 and d3 are the four high-pass filter coefficients or weights associated with each of the high-pass neural processing elements. There can be any number of filter coefficients; four are shown only for purposes of illustration. Sixth high-pass neural processing element 50 is mentioned only as an example of one such element that provides the summation function described above; note that in the embodiment illustrated in FIG. 2 there are a number of other such “nth” high-pass neural processing elements that also provide such a high-pass first-octave output (H^{0,n}), i.e., they satisfy the above-described formula in terms of indices n and k.

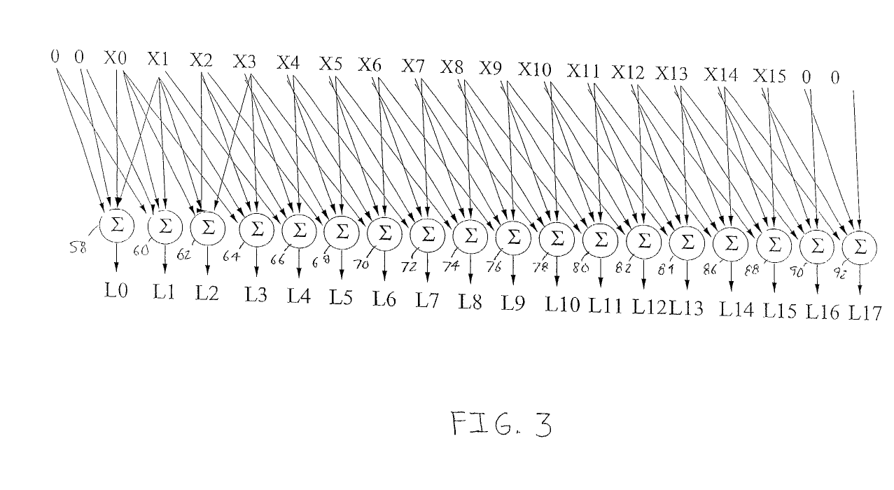

The main difference between a DWT and a CWT is that the DWT downsamples the inputs, whereas the CWT does not. An artificial neural network 10 configured or programmed to perform a DWT has half as many neural processing elements as one configured or programmed to perform a CWT. As illustrated in FIG. 3, an example of a neural network 10 configured or programmed to perform a one-dimensional, one-octave CWT has 16 inputs, X0 through X15, and includes 18 low-pass neural processing elements 58, 60, 62, 64, 66, 68, 70, 72, 74, 76, 78, 80, 82, 84, 86, 88, 90 and 92. Although not illustrated for purposes of clarity, there are also 18 high-pass neural processing elements. As in the embodiment illustrated in FIG. 2, the choice of 16 inputs in this embodiment is arbitrary and for purposes of illustration only; embodiments of the invention can have any suitable number of inputs and correspondingly suitable number of neural processing elements.

As in the embodiment described above and illustrated in FIG. 2, each of the low-pass processing elements and high-pass processing elements receives the same inputs. Each receives four inputs that it multiplies by four corresponding coefficients. Nevertheless, as in the embodiment described above, there can be any number of filter coefficients; four is used only as an example.

Note that there exists at least one low-pass neural processing element (which can be referred to as an “nth” one) that provides a low-pass first-octave output (L_{0,n}) comprising the sum of: the product of a first low-pass filter coefficient and input n−3, the product of a second low-pass filter coefficient and input n−2, the product of a third low-pass filter coefficient and input n−1, and the product of a fourth low-pass filter coefficient and input n. Thus, for example, the fourth (4^{th}) low-pass neural processing element 64 (i.e., n=3) provides a low-pass first-octave output L3 comprising the following sum: X0c0+X1c1+X2c2+X3c3, where c0, c1, c2 and c3 are the four low-pass filter coefficients associated with each of low-pass neural processing elements 58-92.

Similarly, although not shown for purposes of clarity, there exists at least one high-pass neural processing element (which can be referred to as an “nth” one) that provides a high-pass first-octave output (H_{0,n}) comprising the sum of: the product of a first high-pass filter coefficient and input n−3, the product of a second high-pass filter coefficient and input n−2, the product of a third high-pass filter coefficient and input n−1, and the product of a fourth high-pass filter coefficient and input n.

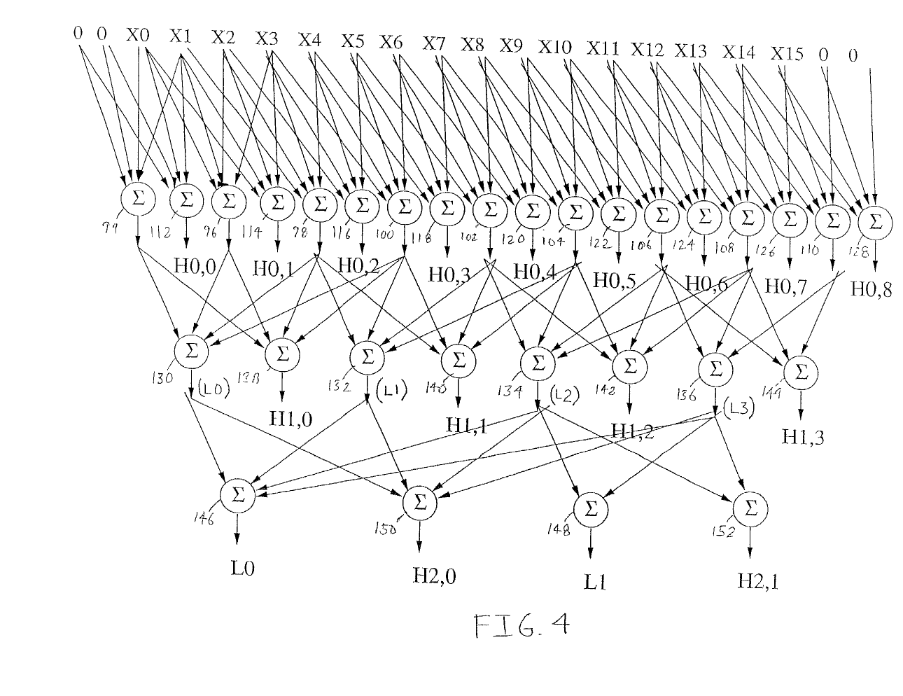

As illustrated in FIG. 4, the concept can be extended to multiple octaves. In this embodiment a neural network 10 is configured or programmed to perform a one-dimensional, three-octave DWT. As in the embodiments described above, there are 16 inputs, X0 through X15, but in addition to the nine low-pass first-octave neural processing elements 94, 96, 98, 100, 102, 104, 106, 108 and 110 and nine high-pass first octave neural processing elements 112, 114, 116, 118, 120, 122, 124, 126 and 128, there are four low-pass second-octave neural processing elements 130, 132, 134 and 136, four high-pass second-octave neural processing elements 138, 140, 142 and 144, two low-pass third-octave neural processing elements 146 and 148, and two high-pass third-octave neural processing elements 150 and 152.

Note that there exists at least one (an “mth” one) of the low-pass neural processing elements that provides a first low-pass second-octave output (L_{1,m}) comprising the sum of: the product of a first low-pass filter coefficient and the low-pass first-octave output of the (n−3)th one of the low-pass neural processing elements, the product of a second low-pass filter coefficient and the low-pass first-octave output of the (n−2)th one of the low-pass neural processing elements, the product of a third low-pass filter coefficient and the low-pass first-octave output of the (n−1)th one of the low-pass neural processing elements, and the product of a fourth low-pass filter coefficient and the low-pass first-octave output of the nth one of the low-pass neural processing elements. In the embodiment illustrated in FIG. 4, “(L0)” is an example of one such (“mth”) first low-pass second-octave output and is provided by low-pass neural processing element 130. The label “(L0)” is shown in parentheses in FIG. 4 to indicate that it is not an actual output of neural network 10 but rather is used as an input to the third octave. In an embodiment in which there is no third octave but rather only two octaves, it would be an actual output of neural network 10.

There also exists another one (an “(m+1)th” one) of the low-pass neural processing elements that provides a second low-pass second-octave output (L_{1, m+1}) comprising the sum of: the product of a first low-pass filter coefficient and the low-pass first-octave output of the (n−1)th one of the low-pass neural processing elements, the product of a second low-pass filter coefficient and the low-pass first-octave output of the nth one of the low-pass neural processing elements, the product of a third low-pass filter coefficient and the low-pass first-octave output of the (n+1)th one of the low-pass neural processing elements, and the product of a fourth low-pass filter coefficient and the low-pass first-octave output of the (n+2)th one of the low-pass neural processing elements. In the embodiment illustrated in FIG. 4, “(L1)” is an example of one such (“(m+1)th”) second low-pass second-octave output and is provided by low-pass neural processing element 132. The label “L1” is shown in parentheses in FIG. 4 to indicate that it is not an actual output of neural network 10 but rather is used as an input to the third octave. In an embodiment in which there is no third octave but rather only two octaves, it would be an actual output of neural network 10.

Similarly, there exists at least one (an “mth” one) of the high-pass neural processing elements that provides a first high-pass second-octave output (H_{1,m}) comprising the sum of: the product of a first high-pass filter coefficient and the low-pass first-octave output of the (n−3)th one of the low-pass neural processing elements, the product of a second high-pass filter coefficient and the low-pass first-octave output of the (n−2)th one of the low-pass neural processing elements, the product of a third high-pass filter coefficient and the low-pass first-octave output of the (n−1)th one of the low-pass neural processing elements, and the product of a fourth high-pass filter coefficient and the low-pass first-octave output of the nth one of the low-pass neural processing elements. In the embodiment illustrated in FIG. 4, H1,0 is an example of one such first high-pass second-octave output and is provided by high-pass neural processing element 130. Note that H1,0 is an actual output of neural network 10 and is not used as an input to the third octave.

There also exists another one (an “(m+1)th” one) of the high-pass neural processing elements that provides a second high-pass second-octave output (H_{1,m+}1) comprising the sum of: the product of a first high-pass filter coefficient and the low-pass first-octave output of the (n−1)th one of the low-pass neural processing elements, the product of a second high-pass filter coefficient and the low-pass first-octave output of the nth one of the low-pass neural processing elements, the product of a third high-pass filter coefficient and the low-pass first-octave output of the (n+1)th one of the low-pass neural processing elements, and the product of a fourth high-pass filter coefficient and the low-pass first-octave output of the (n+2)th one of the low-pass neural processing elements. In the embodiment illustrated in FIG. 4, H1,1 is an example of one such second high-pass second-octave output and is provided by high-pass neural processing element 130. Note that H1,1 is an actual output of neural network 10 and is not used as an input to the third octave.

As noted above, in the embodiment illustrated in FIG. 4 the above-described structure is extended to a third octave and, in other embodiments (not illustrated) can be extended to still further octaves (e.g., a fourth, fifth, sixth, and so forth). Accordingly, third-octave low-pass neural processing elements further provide at least one first low-pass third-octave output, such as that labeled “L0”. Note that this label “L0” is not shown in parentheses because it is an actual output of neural network 10. Similarly, low-pass neural processing elements further provide at least one second low-pass third-octave output, such as that labeled “L1”, not show in parentheses for the same reason. The high-pass neural processing elements also provide at least one first high-pass third-octave output, such as that labeled “H2,0”, and at least one second high-pass third-octave output, such as that labeled “H2,1”. The sums of products that these third-octave outputs provide can be described using essentially the same descriptive notation as that described above with regard to the second-octave, but they are not explicitly set forth herein for purposes of clarity. It is sufficient to note that the same descriptive notation can be applied not only to the second octave but to the third octave as well as any fourth, fifth, or higher octave. Moreover, note that an embodiment of the invention having neural processing elements that provide third or higher-octave outputs inherently also has neural processing elements that provide second-octave outputs, and an embodiment of the invention having neural processing elements that provide second or higher-octave outputs inherently also has neural processing elements that provide first-octave outputs. In other words, because the above-described structure has a regular pattern, the description of a three-octave embodiment inherently also describes and includes a two-octave embodiment. Moreover, in view of the teachings in this patent specification, persons skilled in the art will be enabled to make and use embodiments of the invention having any suitable number of octaves and inputs.

The above-described embodiments of the invention can be extended to multiple dimensions. Some types of digital data, such as that representing images, video and the like, are commonly considered multi-dimensional in the context of applying wavelet transforms. For example, a two-dimensional (2-D) wavelet transform can be applied to a 2-D array of pixels, i.e., representing an image such as a photograph. A 2-D wavelet transform can also be applied to sampled audio signals. A three-dimensional (3-D) wavelet transform can be applied to video, i.e., frames or 2-D arrays of pixels that are sampled at successive points in time, such that time constitutes a third dimension. A 3-D wavelet transform also lends itself to processing of 3-D images, such as those commonly used in geological and medical imaging. Higher-dimensional transforms (e.g., four-dimensional) are useful if, for example, video is accompanied by an audio sound track or other information or, for example, 3-D geological data over time is represented.

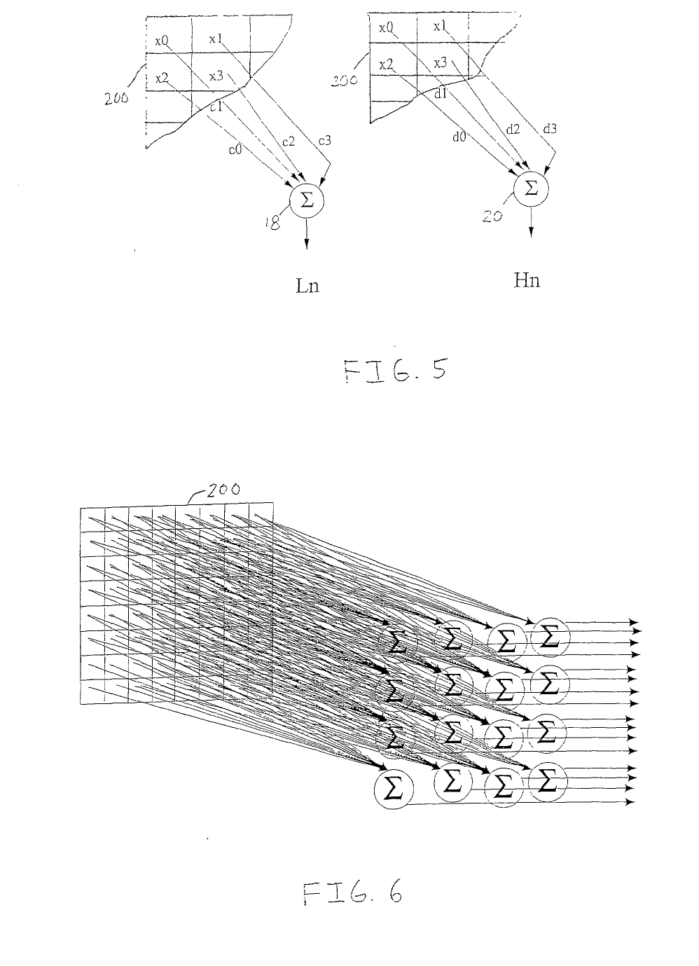

As illustrated in FIG. 5, a 2-D wavelet transform can be performed on pixel data 200 representing an image by configuring neural network 10 as described above and inputting the values of four neighboring pixels as data samples. In the manner described above, low-pass neural processing element 18 provides a low-pass filtered output, and high-pass neural processing element 20 provides a high-pass filtered output. As noted above, although only one low-pass neural processing element 18 and one high-pass neural processing element 20 are illustrated for purposes of clarity, persons skilled in the art can understand that neural network 10 can be any suitable one-octave or multiple-octave embodiment made in the manner described above. Similarly, although only four inputs and four corresponding coefficients are illustrated for purposes of clarity, each neural processing element can have any suitable number of inputs and thus receive the values of any suitable number of neighboring pixels. Note that although a block of only four neighboring pixels is shown for purposes of clarity in FIG. 5, an embodiment having an appropriate number of inputs and neural processing elements can receive as input all of the perhaps thousands of pixels of an image simultaneously. (See FIG. 6.)

Although a 2-D embodiment is described above with regard to processing neighboring pixels that are spatially adjacent, note that the term “neighboring” more generally includes samples within a fixed distance (though not necessarily spatial distance) of each other in any number and type of dimensions. Furthermore, the same method can be applied to samples of data other than that representing pixels. For example, audio samples that are temporally adjacent, i.e., within a fixed time interval of each other, or otherwise neighbor each other in some suitable manner can be input to a similar 2-D embodiment.

It will be apparent to those skilled in the art that various modifications and variations can be made in the present invention without departing from the scope or spirit of the invention. Other embodiments of the invention will be apparent to those skilled in the art as a result of consideration of the specification and practice of the invention disclosed herein. It is intended that the specification and examples be considered as exemplary only, with the true scope and spirit of the invention being indicated by the following claims.

What is claimed is:

1. An artificial neural network configured to perform a discrete wavelet transform, comprising:
an input interface having a plurality of j inputs;
a low-pass filter comprising at least j/2 low-pass neural processing elements, an nth one of the low-pass neural processing elements providing a low-pass first-octave output (L_{0,n}) comprising the sum of: the product of a first low-pass filter coefficient and input 2n−k, the product of a second low-pass filter coefficient and input 2n−(k−1), the product of a third low-pass filter coefficient and input 2n−(k−2), continuing this process until the kth low-pass filter coefficient is multiplied by input 2n, where k is the number of filter coefficients;
a high-pass filter comprising at least j/2 high-pass neural processing elements, an nth one of the high-pass neural processing elements providing a high-pass first-octave output (H_{0,n}) comprising the sum of: a first high-pass filter coefficient and the product of input 2n−k, the product of a second high-pass filter coefficient and input 2n−(k−1), the product of a third high-pass filter coefficient and input 2n−(k−2), continuing this process until the kth high-pass filter coefficient is multiplied by input 2n; and
an output interface having at least j/2 low-pass outputs and at least j/2 high-pass outputs, a low-pass output providing the low-pass first-octave output (L_{0,n}) of the nth one of the low-pass neural processing elements, and a high-pass output providing the high-pass first-octave output (H_{0,n}) of the nth one of the high-pass neural processing elements.

2. The artificial neural network claimed in claim 1, wherein:
an mth one of the low-pass neural processing elements provides a first low-pass second-octave output (L_{1,m}) comprising the sum of: the product of a first low-pass filter coefficient and the low-pass first-octave output of the (n−3)th one of the low-pass neural processing elements, the product of a second low-pass filter coefficient and the low-pass first-octave output of the (n−2)th one of the low-pass neural processing elements, the product of a third low-pass filter coefficient and the low-pass first-octave output of the (n−1)th one of the low-pass neural processing elements, and the product of a fourth low-pass filter coefficient and the low-pass first-octave output of the nth one of the low-pass neural processing elements;
an (m+1)th one of the low-pass neural processing elements provides a second low-pass second-octave output (L_{1,m+1}) comprising the sum of: the product of a first low-pass filter coefficient and the low-pass first-octave output of the (n−1)th one of the low-pass neural processing elements, the product of a second low-pass filter coefficient and the low-pass first-octave output of the nth one of the low-pass neural processing elements, the product of a third low-pass filter coefficient and the low-pass first-octave output of the (n+1)th one of the low-pass neural processing elements, and the product of a fourth low-pass filter coefficient and the low-pass first-octave output of the (n+2)th one of the low-pass neural processing elements;
an mth one of the high-pass neural processing elements provides a first high-pass second-octave output (H_{1,m}) comprising the sum of: the product of a first high-pass filter coefficient and the low-pass first-octave output of the (n−3)th one of the low-pass neural processing elements, the product of a second high-pass filter coefficient and the low-pass first-octave output of the (n−2)th one of the low-pass neural processing elements, the product of a third high-pass filter coefficient and the low-pass first-octave output of the (n−1)th one of the low-pass neural processing elements, and the product of a fourth high-pass filter coefficient and the low-pass first-octave output of the nth one of the low-pass neural processing elements;
an (m+1)th one of the high-pass neural processing elements provides a second high-pass second-octave output (H_{1,m+1}) comprising the sum of: the product of a first high-pass filter coefficient and the low-pass first-octave output of the (n−1)th one of the low-pass neural processing elements, the product of a second high-pass filter coefficient and the low-pass first-octave output of the nth one of the low-pass neural processing elements, the product of a third high-pass filter coefficient and the low-pass first-octave output of the (n+1)th one of the low-pass neural processing elements, and the product of a fourth high-pass filter coefficient and the low-pass first-octave output of the (n+2)th one of the low-pass neural processing elements; and
wherein the low-pass output of the output interface provides the first low-pass second-octave output (L_{1,m}) and the second low-pass second-octave output (L_{1,m+1}), and the high-pass output of the output interface provides the high-pass first-octave output (H_{0,n}), the first high-pass second-octave output (H_{1,m}) and the second low-pass second-octave output (H_{1,m+1}).

3. The artificial neural network claimed in claim 2, wherein:
the low-pass neural processing elements further provide a first low-pass third-octave output;
the low-pass neural processing elements further provide a second low-pass third-octave output;
the high-pass neural processing elements further provide a first high-pass third-octave output; and
the high-pass neural processing elements further provide a second high-pass third-octave output.

4. An artificial neural network configured to perform a continuous wavelet transform, comprising:
an input interface having a plurality of j inputs;
a low-pass filter comprising at least j low-pass neural processing elements, an nth one of the low-pass neural processing elements providing a low-pass first-octave output (L_{0,n}) comprising the sum of: the product of a first low-pass filter coefficient and input n−3, the product of a second low-pass filter coefficient and input n−2, the product of a third low-pass filter coefficient and input n−1, and the product of a fourth low-pass filter coefficient and input n;
a high-pass filter comprising at least j high-pass neural processing elements, an nth one of the high-pass neural processing elements providing a high-pass first-octave output (H_{0,n}) comprising the sum of: a first high-pass filter coefficient and the product of input n−3, the product of a second high-pass filter coefficient and input n−2, the product of a third high-pass filter coefficient and input n−1, and the product of a fourth high-pass filter coefficient and input n; and
an output interface having at least j low-pass outputs and at least j high-pass outputs, a low-pass output providing the low-pass first-octave output (L_{0,n}) of the nth one of the low-pass neural processing elements, and a high-pass output providing the high-pass first-octave output (H_{0,n}) of the nth one of the high-pass neural processing elements.

5. The artificial neural network claimed in claim 4, wherein:
an mth one of the low-pass neural processing elements provides a first low-pass second-octave output (Lₘ) comprising the sum of: the product of a first low-pass filter coefficient and the low-pass first-octave output of the (n−3)th one of the low-pass neural processing elements, the product of a second low-pass filter coefficient and the low-pass first-octave output of the (n−2)th one of the low-pass neural processing elements, the product of a third low-pass filter coefficient and the low-pass first-octave output of the (n−1)th one of the low-pass neural processing elements, and the product of a fourth low-pass filter coefficient and the low-pass first-octave output of the nth one of the low-pass neural processing elements;
an (m+1)th one of the low-pass neural processing elements provides a second low-pass second-octave output (Lₘ₊₁) comprising the sum of: the product of a first low-pass filter coefficient and the low-pass first-octave output of the (n−1)th one of the low-pass neural processing elements, the product of a second low-pass filter coefficient and the low-pass first-octave output of the nth one of the low-pass neural processing elements, the product of a third low-pass filter coefficient and the low-pass first-octave output of the (n+1)th one of the low-pass neural processing elements, and the product of a fourth low-pass filter coefficient and the low-pass first-octave output of the (n+2)th one of the low-pass neural processing elements;
an mth one of the high-pass neural processing elements provides a first high-pass second-octave output (H_{1,m}) comprising the sum of: the product of a first high-pass filter coefficient and the low-pass first-octave output of the (n−3)th one of the low-pass neural processing elements, the product of a second high-pass filter coefficient and the low-pass first-octave output of the (n−2)th one of the low-pass neural processing elements, the product of a third high-pass filter coefficient and the low-pass first-octave output of the (n−1)th one of the low-pass neural processing elements, and the product of a fourth high-pass filter coefficient and the low-pass first-octave output of the nth one of the low-pass neural processing elements;
an (m+1)th one of the high-pass neural processing elements provides a second high-pass second-octave output (H_{1,m+1}) comprising the sum of: the product of a first high-pass filter coefficient and the low-pass first-octave output of the (n−1)th one of the low-pass neural processing elements, the product of a second high-pass filter coefficient and the low-pass first-octave output of the nth one of the low-pass neural processing elements, the product of a third high-pass filter coefficient and the low-pass first-octave output of the (n+1)th one of the low-pass neural processing elements, and the product of a fourth high-pass filter coefficient and the low-pass first-octave output of the (n+2)th one of the low-pass neural processing elements; and
wherein the low-pass output of the output interface provides the first low-pass zsecond-octave output (Lₘ) and the second low-pass second-octave output (Lₘ₊₁), and the high-pass output of the output interface provides the high-pass first-octave output (H_{0,n}), the first high-pass second-octave output (H_{1,m}) and the second low-pass second-octave output (H_{1 m+1}).

6. The artificial neural network claimed in claim 5, wherein:
the low-pass neural processing elements further provide a first low-pass third-octave output;
the low-pass neural processing elements further provide a second low-pass third-octave output;
the high-pass neural processing elements further provide a first high-pass third-octave output; and
the high-pass neural processing elements further provide a second high-pass third-octave output.

7. A method for performing a two-dimensional wavelet transform, comprising the steps of:
inputting at least four neighboring data samples;
low-pass filtering the data samples by providing the data samples to a low-pass filter comprising one or more low-pass neural processing elements, an nth one of the low-pass neural processing elements providing a low-pass output comprising the sum of: the product of a first low-pass filter coefficient and a first one of the data samples, the product of a second low-pass filter coefficient and a second one of the data samples, the product of a third low-pass filter coefficient and a third one of the data samples, and the product of a fourth low-pass filter coefficient and a fourth one of the data samples;
low-pass filtering the data samples by providing the data samples to a low-pass filter comprising one or more low-pass neural processing elements, an nth one of the low-pass neural processing elements providing a low-pass output comprising the sum of: the product of a first low-pass filter coefficient and a first one of the data samples, the product of a second low-pass filter coefficient and a second one of the data samples, the product of a third low-pass filter coefficient and a third one of the data samples, and the product of a fourth low-pass filter coefficient and a fourth one of the data samples;
outputting the low-pass output of the nth one of the low-pass neural processing elements; and
outputting the high-pass output of the nth one of the high-pass neural processing elements.

8. The method claimed in claim 7, wherein the inputting step comprises inputting a block of spatially neighboring pixels representing a selected area of an image.

9. The method claimed in claim 7, wherein the inputting step comprises inputting a sequence of temporally neighboring audio signals representing a selected time interval of sound.

10. An artificial neural network configured as a filter, comprising:
an input interface having at least four inputs; and
a filter comprising a plurality of neural processing elements, an nth one of the neural processing elements providing an output comprising the sum of: a first filter coefficient and the product of input 2n−3, the product of a second filter coefficient and input 2n−2, the product of a third filter coefficient and input 2n−1, and the product of a fourth filter coefficient and input 2n, and an (n+1)th one of the neural processing elements providing an output comprising the sum of: a first filter coefficient and the product of input 2(n+1)−3, the product of a second filter coefficient and input 2(n+1)−2, the product of a third filter coefficient and input 2(n+1)−1, and the product of a fourth filter coefficient and input 2(n+1).

11. The artificial neural network claimed in claim 10, wherein the filter coefficients have values defining low-pass filtration.

12. The artificial neural network claimed in claim 10, wherein the filter coefficients have values defining band-pass filtration.

13. The artificial neural network claimed in claim 10, wherein the filter coefficients have values defining high-pass filtration.

14. The artificial neural network claimed in claim 1, wherein:
an mth one of the low-pass neural processing elements provides a first low-pass second-octave output (L_{1,m}) comprising the sum of: the product of a first low-pass filter coefficient and the high-pass first-octave output of the (n−3)th one of the high-pass neural processing elements, the product of a second low-pass filter coefficient and the high-pass first-octave output of the (n−2)th one of the high-pass neural processing elements, the product of a third low-pass filter coefficient and the high-pass first-octave output of the (n−1)th one of the high-pass neural processing elements, and the product of a fourth low-pass filter coefficient and the high-pass first-octave output of the nth one of the high-pass neural processing elements;
an (m+1)th one of the low-pass neural processing elements provides a second low-pass second-octave output (L_{1,m+1}) comprising the sum of: the product of a first low-pass filter coefficient and the high-pass first-octave output of the (n−1)th one of the high-pass neural processing elements, the product of a second low-pass filter coefficient and the high-pass first-octave output of the nth one of the high-pass neural processing elements, the product of a third low-pass filter coefficient and the high-pass first-octave output of the (n+1)th one of the high-pass neural processing elements, and the product of a fourth low-pass filter coefficient and the high-pass first-octave output of the (n+2)th one of the high-pass neural processing elements;
an mth one of the high-pass neural processing elements provides a first high-pass second-octave output (H_{1,m}) comprising the sum of: the product of a first high-pass filter coefficient and the high-pass first-octave output of the (n−3)th one of the high-pass neural processing elements, the product of a second high-pass filter coefficient and the high-pass first-octave output of the (n−2)th one of the high-pass neural processing elements, the product of a third high-pass filter coefficient and the high-pass first-octave output of the (n−1)th one of the high-pass neural processing elements, and the product of a fourth high-pass filter coefficient and the high-pass first-octave output of the nth one of the high-pass neural processing elements;
an (m+1)th one of the high-pass neural processing elements provides a second high-pass second-octave output (H_{1,m+1}) comprising the sum of: the product of a first high-pass filter coefficient and the high-pass first-octave output of the (n−1)th one of the high-pass neural processing elements, the product of a second high-pass filter coefficient and the high-pass first-octave output of the nth one of the high-pass neural processing elements, the product of a third high-pass filter coefficient and the high-pass first-octave output of the (n+1)th one of the high-pass neural processing elements, and the product of a fourth high-pass filter coefficient and the high-pass first-octave output of the (n+2)th one of the high-pass neural processing elements; and
wherein the low-pass output of the output interface provides the first low-pass second-octave output (L₁,m) and the second low-pass second-octave output (L_{1,m+1}), and the high-pass output of the output interface provides the high-pass first-octave output (H_{0,n}), the first high-pass second-octave output (H_{1,m}) and the second low-pass second-octave output (H_{1,m+1}).

15. A method for configuring an artificial neural network having an input interface with at least a plurality of j inputs to perform a discrete wavelet transform, said neural network, and a plurality of neural processing elements, the method comprising the steps of:
configuring at least j/2 (low-pass) neural processing elements to define a low-pass filter by arranging an nth one of the low-pass neural processing elements to provide a low-pass first-octave output (L_{0,n}) comprising the sum of: the product of a first low-pass filter coefficient and input 2n−k, the product of a second low-pass filter coefficient and input 2n−(k−1), the product of a third low-pass filter coefficient and input 2n−(k−2), continuing this process until the kath low-pass filter coefficient is multiplied by input 2n, where k is the number of filter coefficients;
configuring at least j/2 (high-pass) neural processing elements to define a high-pass filter by arranging an nth one of the high-pass neural processing elements to provide a high-pass first-octave output (H_{0,n}) comprising the sum of: a first high-pass filter coefficient and the product of input 2n−k, the product of a second high-pass filter coefficient and input 2n−(k−1), the product of a third high-pass filter coefficient and input 2n−(k−2), continuing this process until the kth high-pass filter coefficient is multiplied by input 2n; and
providing at an output interface at least j/2 low-pass outputs and at least j/2 high-pass outputs, a low-pass output providing the low-pass first-octave output (L_{0,n}) of the nth one of the low-pass neural processing elements, and a high-pass output providing the high-pass first-octave output (H_{0,n}) of the nth one of the high-pass neural processing elements.

16. The method claimed in claim 15, wherein:
an mth one of the low-pass neural processing elements provides a first low-pass second-octave output (L_{1,m}) comprising the sum of: the product of a first low-pass filter coefficient and the low-pass first-octave output of the (n−3)th one of the low-pass neural processing elements, the product of a second low-pass filter coefficient and the low-pass first-octave output of the (n−2)th one of the low-pass neural processing elements, the product of a third low-pass filter coefficient and the low-pass first-octave output of the (n−1)th one of the low-pass neural processing elements, and the product of a fourth low-pass filter coefficient and the low-pass first-octave output of the nth one of the low-pass neural processing elements;
an (m+1)th one of the low-pass neural processing elements provides a second low-pass second-octave output (L_{1,m+1}) comprising the sum of: the product of a first low-pass filter coefficient and the low-pass first-octave output of the (n−1)th one of the low-pass neural processing elements, the product of a second low-pass filter coefficient and the low-pass first-octave output of the nth one of the low-pass neural processing elements, the product of a third low-pass filter coefficient and the low-pass first-octave output of the (n+1)th one of the low-pass neural processing elements, and the product of a fourth low-pass filter coefficient and the low-pass first-octave output of the (n+2)th one of the low-pass neural processing elements;
an mth one of the high-pass neural processing elements provides a first high-pass second-octave output (H_{1,m}) comprising the sum of: the product of a first high-pass filter coefficient and the low-pass first-octave output of the (n−3)th one of the low-pass neural processing elements, the product of a second high-pass filter coefficient and the low-pass first-octave output of the (n−2)th one of the low-pass neural processing elements, the product of a third high-pass filter coefficient and the low-pass first-octave output of the (n−1)th one of the low-pass neural processing elements, and the product of a fourth high-pass filter coefficient and the low-pass first-octave output of the nth one of the low-pass neural processing elements;
an (m+1)th one of the high-pass neural processing elements provides a second high-pass second-octave output (H_{1,m+1}) comprising the sum of: the product of a first high-pass filter coefficient and the low-pass first-octave output of the (n−1)th one of the low-pass neural processing elements, the product of a second high-pass filter coefficient and the low-pass first-octave output of the nth one of the low-pass neural processing elements, the product of a third high-pass filter coefficient and the low-pass first-octave output of the (n+1)th one of the low-pass neural processing elements, and the product of a fourth high-pass filter coefficient and the low-pass first-octave output of the (n+2)th one of the low-pass neural processing elements; and
wherein the low-pass output of the output interface provides the first low-pass second-octave output (L_{1,m}) and the second low-pass second-octave output (L_{1,m+1}), and the high-pass output of the output interface provides the high-pass first-octave output (H_{0,n}), the first high-pass second-octave output (H_{1,m}) and the second low-pass second-octave output (H_{1,m+1}).

17. The method claimed in claim 16, wherein:
the low-pass neural processing elements further provide a first low-pass third-octave output;
the low-pass neural processing elements further provide a second low-pass third-octave output;
the high-pass neural processing elements further provide a first high-pass third-octave output; and
the high-pass neural processing elements further provide a second high-pass third-octave output.

18. A method for configuring an artificial neural network having an input interface with a plurality of at least j inputs to perform a continuous wavelet transform, said neural network having a plurality of neural processing elements, the method comprising the steps of:
configuring at least j (low-pass) neural processing elements to define a low-pass filter by arranging an nth one of the low-pass neural processing elements to provide a low-pass first-octave output (L_{0,n}) comprising the sum of: the product of a first low-pass filter coefficient and input n−3, the product of a second low-pass filter coefficient and input n−2, the product of a third low-pass filter coefficient and input n−1, and the product of a fourth low-pass filter coefficient and input n;
configuring at least j high-pass neural processing elements to define a high-pass filter by arranging an nth one of the high-pass neural processing elements to provide a high-pass first-octave output (H_{0,n}) comprising the sum of: a first high-pass filter coefficient and the product of input n−3, the product of a second high-pass filter coefficient and input n−2, the product of a third high-pass filter coefficient and input n−1, and the product of a fourth high-pass filter coefficient and input n; and
providing at an output interface at least j low-pass outputs and at least j high-pass outputs, a low-pass output providing the low-pass first-octave output (L_{0,n}) of the nth one of the low-pass neural processing elements, and a high-pass output providing the high-pass first-octave output (H_{0,n}) of the nth one of the high-pass neural processing elements.

19. The method claimed in claim 18, wherein:
an mth one of the low-pass neural processing elements provides a first low-pass second-octave output (Lₘ) comprising the sum of: the product of a first low-pass filter coefficient and the low-pass first-octave output of the (n−3)th one of the low-pass neural processing elements, the product of a second low-pass filter coefficient and the low-pass first-octave output of the (n−2)th one of the low-pass neural processing elements, the product of a third low-pass filter coefficient and the low-pass first-octave output of the (n−1)th one of the low-pass neural processing elements, and the product of a fourth low-pass filter coefficient and the low-pass first-octave output of the nth one of the low-pass neural processing elements;
an (m+1)th one of the low-pass neural processing elements provides a second low-pass second-octave output (Lₘ₊₁) comprising the sum of: the product of a first low-pass filter coefficient and the low-pass first-octave output of the (n−1)th one of the low-pass neural processing elements, the product of a second low-pass filter coefficient and the low-pass first-octave output of the nth one of the low-pass neural processing elements, the product of a third low-pass filter coefficient and the low-pass first-octave output of the (n+1)th one of the low-pass neural processing elements, and the product of a fourth low-pass filter coefficient and the low-pass first-octave output of the (n+2)th one of the low-pass neural processing elements;
an mth one of the high-pass neural processing elements provides a first high-pass second-octave output (H_{1,m}) comprising the sum of: the product of a first high-pass filter coefficient and the low-pass first-octave output of the (n−3)th one of the low-pass neural processing elements, the product of a second high-pass filter coefficient and the low-pass first-octave output of the (n−2)th one of the low-pass neural processing elements, the product of a third high-pass filter coefficient and the low-pass first-octave output of the (n−1)th one of the low-pass neural processing elements, and the product of a fourth high-pass filter coefficient and the low-pass first-octave output of the nth one of the low-pass neural processing elements;
an (m+1)th one of the high-pass neural processing elements provides a second high-pass second-octave output (H_{1,m+1}) comprising the sum of: the product of a first high-pass filter coefficient and the low-pass first-octave output of the (n−1)th one of the low-pass neural processing elements, the product of a second high-pass filter coefficient and the low-pass first-octave output of the nth one of the low-pass neural processing elements, the product of a third high-pass filter coefficient and the low-pass first-octave output of the (n+1)th one of the low-pass neural processing elements, and the product of a fourth high-pass filter coefficient and the low-pass first-octave output of the (n+2)th one of the low-pass neural processing elements; and
wherein the low-pass output of the output interface provides the first low-pass second-octave output (Lₘ) and the second low-pass second-octave output (Lₘ₊₁), and the high-pass output of the output interface provides the high-pass first-octave output (H_{0,n}), the first high-pass second-octave output (H_{1,m}) and the second low-pass second-octave output (H_{1 m+1}).

20. The method claimed in claim 19, wherein:
the low-pass neural processing elements further provide a first low-pass third-octave output;
the low-pass neural processing elements further provide a second low-pass third-octave output;
the high-pass neural processing elements further provide a first high-pass third-octave output; and
the high-pass neural processing elements further provide a second high-pass third-octave output.

21. A method for configuring an artificial neural network as a filter, the neural network having at least four inputs, the method comprising the steps of:
configuring an nth one of the neural processing elements to provide an output comprising the sum of: a first filter coefficient and the product of input 2n−3, the product of a second filter coefficient and input 2n−2, the product of a third filter coefficient and input 2n−1, and the product of a fourth filter coefficient and input 2n, and an (n+1)th one of the neural processing elements providing an output comprising the sum of: a first filter coefficient and the product of input 2(n+1)−3, the product of a second filter coefficient and input 2(n+1)−2, the product of a third filter coefficient and input 2(n+1)−1, and the product of a fourth filter coefficient and input 2(n+1).

22. The method claimed in claim 21, wherein the configuring step includes assigning filter coefficients having values defining low-pass filtration.

23. The method claimed in claim 21, wherein the configuring step includes assigning filter coefficients have values defining band-pass filtration.

24. The method claimed in claim 21, wherein the configuring step includes assigning filter coefficients have values defining high-pass filtration.
